(19) United States
(12) Patent Application Publication
(10) Pub. No.: US 2009/0241547 A1
(43) Pub. Date: Oct. 1, 2009

(54) Gas turbine fuel injector for lower heating capacity fuels

(76) Inventors: Andrew Luts, Escondido, CA (US); Jeffrey Scott Gordon, Houston, TX (US); Gerardo Michael Zozula, San Diego, CA (US); Michael Jock Telfer, San Diego, CA (US); Yungmo Kang, San Diego, CA (US); Hongyu Wang, San Diego, CA (US)

Correspondence Address: CATERPILLAR/FINNEGAN, HENDERSON, L.L.P., 901 New York Avenue, NW, WASHINGTON, DC, 20001-4413, US

(21) Appl. No.: 12/078,407

(22) Filed: Mar. 31, 2008

(51) Int. Cl. F02C 7/22

(52) U.S. Cl. 60/737; 60/740; 60/776; 60/746

(57) ABSTRACT

A fuel injector for a gas turbine engine includes a stem extending along a longitudinal axis from a proximal end to a distal end. The stem includes one or more fuel tubes configured to deliver a fuel toward the distal end of the stem, and a pilot assembly coupled to the distal end of the stem. The pilot assembly includes one or more components configured to inject fuel into a combustor of the engine. The fuel injector also includes a substantially tubular premix barrel extending along the longitudinal axis from a first end to a second end. The premix barrel is circumferentially disposed about the stem and configured to couple with the combustor at the second end. The fuel injector also includes an annular premix duct formed between the premix barrel and the stem. The premix duct includes an air inlet port at the first end, and a plurality of first orifices located downstream of the air inlet port. The first orifices are configured to inject fuel from the fuel tube into the premix duct. The premix duct also includes a plurality of second orifices located downstream of the first orifices. The second orifices are configured to inject fuel from the fuel tube into the premix duct.

### TECHNICAL FIELD

The present disclosure relates generally to a fuel injector for a gas turbine engine, and more particularly, to a gas turbine fuel injector suitable for medium and low BTU fuels.

### BACKGROUND

Gas turbine engines (“GTEs”) produce power by extracting energy from a flow of hot gas produced by combustion of a fuel in a stream of compressed air. In general, GTE's have a combustion chamber (combustor) coupled to an air compressor and a turbine. Energy is released when a mixture of compressed air and fuel is ignited in the combustor. The resulting hot gases are directed over the turbine's blades, spinning the turbine, thereby, producing mechanical power. Many different gaseous fuels may be used in GTEs. In general, these fuels may be characterized as HBTU, MBTU, and LBTU (High, Medium, and Low BTU) fuels based on the combustion energy of the fuel gas. “Wobbe index” is a measure of the combustion energy of a fuel gas. Wobbe index is a ratio of the calorific value of the fuel to the square root of its specific gravity. In terms of combustion energy, HBTU, MBTU, and LBTU fuels may have Wobbe indices of greater than or equal to 1000 BTU/scf (standard cubic feet), 300-1000 BTU/scf, and less than 300 BTU/scf, respectively. A fuel gas with a combustion energy of 1000 BTU/scf may sometimes be referred to as a 1000 Wobbe fuel. The higher the Wobbe number of a gas, the greater is the heating capacity of a quantity of gas that will flow though a hole (or, an injector of a GTE) of a given size in a given amount of time. For the same mass flow rate of fuel gas, the higher the heating capacity of the gas, the higher the power output of a GTE using the gas as fuel. Using a fuel gas of a lower heating capacity would require an increased quantity of fuel to be delivered to the injector (per unit of time) to produce the same amount of power.

Natural gas is a commonly used HBTU fuel in a GTE (≈1200 Wobbe). Natural gas is a gaseous fossil fuel, containing primarily about 80-99% methane and small amounts of heavy hydrocarbons such as ethane, propane, butane, pentane, etc. Fuel grade natural gas is produced by refining raw gas produced as a byproduct in oil fields. With decreasing methane concentration, the Wobbe index of natural gas decreases. Biogas, such as landfill gas, digester gas, etc. may be MBTU gases that may be produced by the biological breakdown of organic matter in the absence of oxygen. These biogases contain varying levels of methane. For example, landfill gas may contain about 40-60% methane with the remainder being mostly carbon dioxide (CO₂), and have a Wobbe index of between about 300-800 Wobbe. Digester gas may contain higher amounts of methane than landfill gas, and have a Wobbe index of between about 600-800 Wobbe. Due to lower refining requirements of MBTU gases, these MBTU gases may be used as a low cost alternative fuel for GTE's. From a cost standpoint, some users of natural gas burning GTE's may find it advantageous to replace natural gas fuel with a lower BTU fuel, such as landfill gas (or another MBTU or LBTU fuel gas), while making minimal modifications to the GTE. Since the heating capacity of MBTU and LBTU fuels are lower than that of natural gas, an increased amount of these fuel gases need to be delivered to the combustor to produce the same amount of power as a GTE burning natural gas. Increasing the mass flow rate of fuel delivered through fuel injectors of the GTE may require an increase in the fuel delivery pressure. Increasing the fuel delivery pressure may necessitate larger pumps and more energy to compress the fuel. Larger pumps may increase the cost of GTE, and an increase in energy consumption may decrease the useful power output, and efficiency of the GTE.

U.S. Pat. No. 5,839,283 issued to Döbbeling (the '283 patent) discloses a gas turbine engine having multiple annular rows of premix ducts arranged around an annular combustor. The multiple annular rows of premix ducts of the '283 patent delivers a sufficient amount of MBTU fuel gas to the annular combustor. While the solution disclosed by the '283 patent may deliver an increased volume of MBTU fuel to the combustor, incorporating the multiple annular rows of premix ducts on a GTE burning natural gas may require redesign of the GTE.

### SUMMARY OF THE INVENTION

In one aspect, a fuel injector for a gas turbine engine is disclosed. The fuel injector includes a stem extending along a longitudinal axis from a proximal end to a distal end. The stem includes one or more fuel tubes configured to deliver a fuel to toward the distal end of the stem, and a pilot assembly coupled to the distal end of the stem. The pilot assembly includes one or more components configured to inject fuel into a combustor of the engine. The fuel injector also includes a substantially tubular premix barrel extending along the longitudinal axis from a first end to a second end. The premix barrel is circumferentially disposed about the stem and configured to couple with the combustor at the second end. The fuel injector also includes an annular premix duct formed between the premix barrel and the stem. The premix duct includes an air inlet port at the first end, and a plurality of first orifices located downstream of the air inlet port. The first orifices are configured to inject fuel from the fuel tube into the premix duct. The premix duct also includes a plurality of second orifices located downstream of the first orifices. The second orifices are configured to inject fuel from the fuel tube into the premix duct.

In another aspect, a method of delivering a fuel to a gas turbine engine using a fuel injector is disclosed. The method includes directing a first part of the fuel into a combustor of the engine as a fuel-air stream through a pilot assembly, and injecting a second part of the fuel into a stream of compressed air at a first location to form a fuel-air mixture. The method also includes moving the fuel-air mixture to a second location downstream of the first location, and injecting a third part of the fuel into the fuel-air mixture at the second location. The method further includes directing the fuel-air mixture into the combustor after the injection of the third part of fuel.

In yet another aspect, a gas turbine engine is disclosed. The gas turbine engine includes a compressor, and a combustor fluidly coupled to the compressor and annularly disposed about a first longitudinal axis. The combustor is configured to produce combustion gases by burning a fuel. The gas turbine engine also includes a plurality of fuel injectors configured to deliver the fuel to the combustor. At least one fuel injector of the plurality includes one or more fuel tubes extending along a second longitudinal axis, and a pilot assembly disposed along the second longitudinal axis and configured to inject the fuel into the combustor. The fuel injector also includes a substantially cylindrical premix barrel disposed radially outwards of the pilot assembly and extending from an air inlet port at a first end to the combustor at a second end opposite the first end. The premix barrel forms an annular premix duct in a space between the premix barrel and the pilot assembly. The fuel injector also includes a plurality of first orifices located downstream of the air inlet port. The first orifices are configured to inject fuel from the fuel tube into the premix duct. The fuel injector also includes a plurality of second orifices located downstream of the first orifices. The second orifices are configured to inject fuel from the fuel tube into the premix duct. The gas turbine engine also includes a turbine configured to extract power from the combustion gases.

### BRIEF DESCRIPTION OF THE DRAWINGS

FIG. 1 is an illustration of an exemplary disclosed GTE;

FIG. 2 is a cutaway illustration of an exemplary combustor system of the GTE of FIG. 1;

FIG. 3 is a cutaway illustration of an exemplary prior art HBTU gas burning fuel injector of the GTE of FIG. 1;

FIG. 4A is a cutaway illustration of an exemplary MBTU/LBTU gas burning fuel injector of the GTE of FIG. 1; and

FIG. 4B is a cross-sectional illustration of the fuel injector of FIG. 4A.

### DETAILED DESCRIPTION

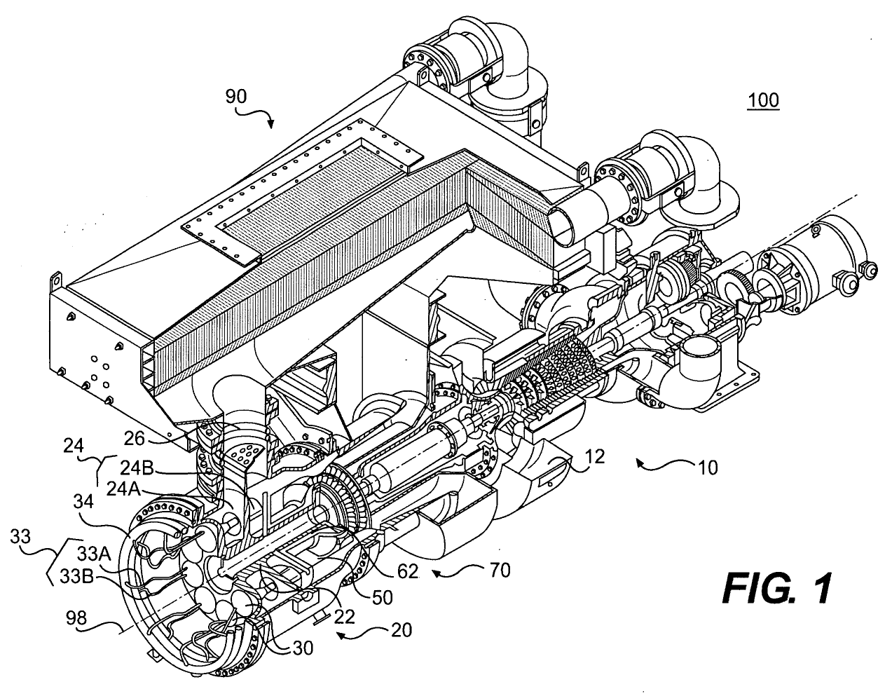

FIG. 1 illustrates an exemplary gas turbine engine (GTE) 100. GTE 100 may have, among other systems, a compressor system 10, a combustor system 20, a turbine system 70, and an exhaust recuperator system 90. Compressor system 10 may compress incoming air from an air inlet 12 to a high pressure and direct the air to an air duct 26 to combustor system 20. The combustor system 20 may mix a gaseous fuel with the compressed air and burn the fuel-air mixture to produces a high-pressure, high-velocity gas that may be directed to the turbine system 70. The turbine system 70 may extract energy from the high-pressure, high-velocity gas flowing from the combustor system 20 and direct the exhaust to recuperator system 90. Recuperator system 90 may recover a portion of the waste heat from the exhaust gases, and discharge these gases to the atmosphere. In this discussion, only those aspects of GTE 100 useful to describe the disclosed fuel injector will be discussed. Combustor system 20 may include an annular combustor 50 configured to burn the fuel-air mixture directed to the combustor 50 through a plurality of fuel injectors 30 annularly positioned about a longitudinal axis 98 of GTE 100.

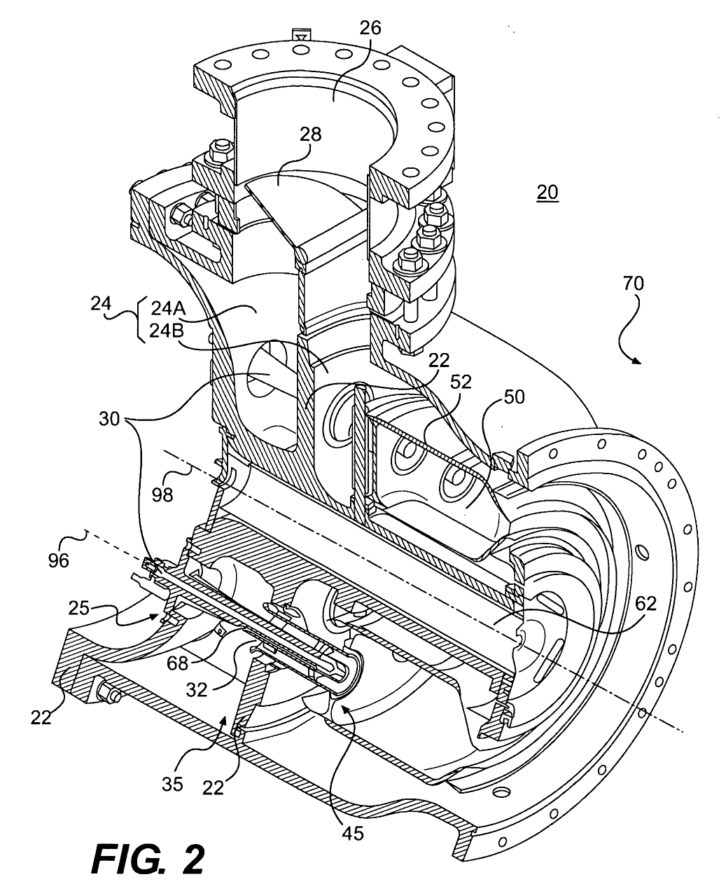

FIG. 2 is a cutaway illustration of combustor system 20. In the description that follows, reference will be made to both FIGS. 1 and 2. Combustor 50 may include an annular region located about longitudinal axis 98. Combustor 50 may be positioned inside of a liner 52 extending along longitudinal axis 98. A shaft (not shown) of GTE 100 may extend along central cavity 62. A plurality of fuel injectors 30 may be annularly positioned about longitudinal axis 98 on one end face of combustor 50. In some embodiments, eight fuel injectors 30 may be used with combustor 50. However, in general, the number of fuel injectors 30 may depend upon the application. Fuel duct 33 may deliver fuel from fuel manifold 34 to fuel injector 30 (see FIG. 1). Compressed air from compressor system 10 may also be delivered to combustor system 20 through air duct 26. The compressed air may be delivered through air duct 26 to an enclosed space 24 surrounding fuel injector 30. This enclosed space 24 may be further divided into a first space 24A and a second space 24B. An air diverter valve (ADV 28), positioned in compressed air duct 26, may portion compressed air, delivered through compressed air duct 26, between first space 24A and second space 24B. The position of ADV 28 may determine the relative proportion of compressed air delivered to first space 24A and second space 24B. The portion of compressed air in second space 24B may be used to cool liner 52, and the portion of compressed air in first space 24A may be directed into fuel injector 30 through an air inlet port 32 and an air passage 68.

Fuel injector 30 may include a cylindrical assembly extending from a first end 45 to a second end 25 along a longitudinal axis 96. First end 45 of fuel injector 30 may be positioned in combustor 50, and a second end 25 (opposite first end 45) may be coupled to a casing 22 of combustor system 20. Fuel injector 30 may also abut against casing 22 at a midsection 35, such that a length of fuel injector 30 between first end 45 and midsection 35 may be located within second space 24B, and a length of fuel injector 30 between midsection 35 and second end 25 may be located within first space 24A. Air inlet port 32 and air passage 68, that directs compressed air from first space 24A into fuel injector 30, may be located in the length of fuel injector 30 positioned in first space 24A. Fuel delivered to fuel injector 30 through fuel duct 33 (see FIG. 1) may mix with the compressed air directed into fuel injector 30 through air inlet port 32 to form a fuel-air mixture. This fuel-air mixture may be directed to combustor 50 through first end 45 of fuel injector 30. Fuel injector 30 may include different components that together deliver multiple streams of fuel to combustor 50 along different flow paths. In some embodiments, these multiple streams may include a main fuel stream delivered along a main flow path and a pilot fuel stream delivered along a pilot flow path. The amount of flow and/or the concentration of fuel (in the fuel-air mixture) delivered to combustor 50 through these multiple flow paths may be controlled to achieve stable combustion with minimal formation of pollutants such as CO, NOₓ, etc.

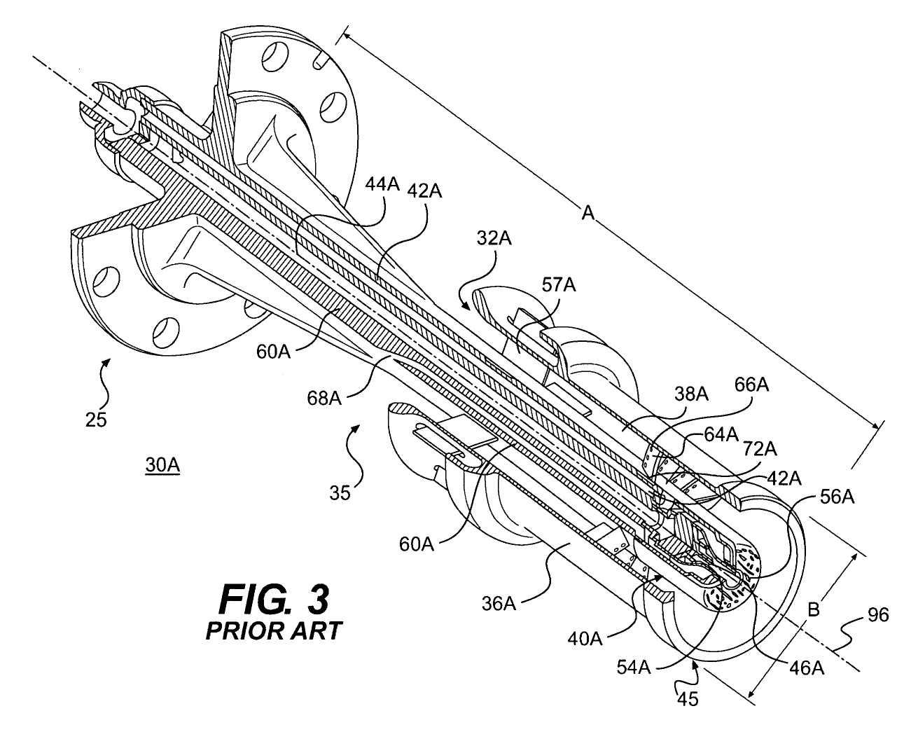

FIG. 3 is a cutaway view of a prior art fuel injector 30A that may be used to deliver a HBTU fuel gas to GTE 100. Description of fuel injector 30A is included herein to highlight the differences between a prior art fuel injector and a fuel injector of the current disclosure. In the description that follows reference will be made to both FIGS. 2 and 3. Fuel injector 30A may have a generally cylindrical stem 60A extending along longitudinal axis 96 from second end 25 towards first end 45 of fuel injector 30A. A substantially tubular premix barrel 36A may be circumferentially disposed around stem 60A. A pilot assembly 40A may be coupled with stem 60A proximate the first end 45 of fuel injector 30, such that pilot assembly 40A may be positioned radially inwards of premix barrel 36A. One or more support structures 57A may position premix barrel 36A circumferentially around stem 60A and pilot assembly 40A. An annular space between premix barrel 36A and stem 60A may form a main fuel duct 38A of fuel injector 30A. Main fuel duct 38A may form the main flow path of fuel injector 30A, and may deliver a premixed fuel-air mixture to combustor 50. This premixed fuel-air mixture may burn in combustor 50 to create premixed flames. Premixed flames are flames that are created when fuel and air are first mixed in fuel injector 30A and then burned in combustor 50. The concentration of fuel and air in the premixed fuel-air mixture may be configured to reduce NOₓand CO emissions if desired. Pilot assembly 40A may include multiple components and passages that form the pilot fuel flow path of fuel injector 30A. The pilot fuel flow path may deliver a stream of pressurized fuel and air to combustor 50. This pressurized stream of fuel and air may create a diffusion flame in combustor 50. Diffusion flames are flames that are created when fuel and air mix and burn at the same time. Diffusion flames may have a higher flame temperature than premixed flames, and may serve as a localized hot flame to stabilize the combustion process and prevent flame extinguishment.

Although dimensions of fuel injector 30A may depend upon the application, in some embodiments fuel injector 30A may have a total length (A) between first end 45 and second end 25 of between about 380 mm and 635 mm, and a diameter (B) of premix barrel 36A at first end 45 of between about 50 mm and 152 mm. As shown in FIG. 1, fuel from fuel manifold 34 may be delivered to fuel injector 30A through fuel duct 33. Fuel duct 33 may include a main duct 33A and a pilot duct 33B (shown in FIG. 1). Main duct 33A may supply fuel for the main fuel flow path, and pilot duct 33B may supply fuel for the pilot fuel flow path. Main duct 33A may include a tube or a conduit that fluidly couples fuel manifold 34 to a main fuel tube (or cavity) 42A of fuel injector 30A. Main fuel tube 42A may extend from second end 25 towards first end 45 through stem 60A of fuel injector 30A. Pilot duct 33B may include a tube or a conduit that fluidly couples fuel manifold 34 to a pilot fuel tube (not shown) of fuel injector 30A. In the illustration of fuel injector 30A shown in FIG. 3, the pilot fuel tube has been removed for clarity. The pilot fuel tube may include one or more elongate tubes that extend from second end 25 to a pilot fuel nozzle 46A at first end 45 of fuel injector 30A along a cavity 44A of (or tube through) stem 60A. Pilot fuel nozzle 46A may inject a stream of fuel into combustor 50. Fuel injector 30A may include air passage 68A that may deliver compressed air from first space 24A into pilot assembly 40A. Air passage 68A may include one or more passages that passes through stem 60A and directs compressed air from first space 24A to pilot assembly 40A, as shown in FIG. 2. A portion of the compressed air entering pilot assembly 40A may be injected, along with the fuel injection from pilot fuel nozzle 46A, into combustor 50. The compressed air may be injected through air nozzles 54A (or ducts) located around pilot fuel nozzle 46A. The remaining portion of compressed air entering pilot assembly 40A may be delivered to combustor 50 through perforations 56A at first end 45 of pilot assembly 40A. The portion of air entering combustor 50 through perforations 56A may cool first end 45 of pilot assembly 40A.

During startup, a large portion of the total fuel delivered to combustor 50 may be directed through pilot assembly 40A. After startup, the proportion of fuel delivered through the pilot assembly 40A may be reduced to between about 1 to 10%. Thus, during normal operation, a majority of the fuel delivered to combustor 50 may be delivered as premixed fuel-air mixture through main fuel duct 38A. Fuel in main fuel tube 42A may be injected into the compressed air flowing through main fuel duct 38A through second orifices 66A located on air swirler 64A.

Air swirler 64A may include a plurality of straight or curved blades, attached to an external surface of stem 60A downstream of air inlet port 32A. While the location and number of blades of air swirler 64A may depend upon the application, in some embodiments, 10 to 14 blades may be symmetrically located around longitudinal axis 96. Air swirler 64A may be configured to swirl the compressed air flowing past the blades of air swirler 64A. Swirling the compressed air may help mix the fuel thoroughly with the air. Second orifices 66A may include a plurality of small openings located on the blades of air swirler 64A. Although second orifices 66A may be located anywhere on air swirler 64A, in some embodiments, second orifices 66A may be located on the upstream side of air swirler 64A. A second fuel gallery 72A may fluidly couple second orifices 66A to main fuel tube 42A. Second fuel gallery 72A may include an annular cavity on stem 60A. Passages (not shown) may connect second fuel gallery 72A to main fuel tube 42A and second orifices 66A. The fuel injected through second orifices 66A may mix with the compressed air flowing past air swirler 64A and form a premixed fuel-air mixture. This premixed fuel air mixture may enter combustor 50 through first end 45 of fuel injector 30A.

Although fuel injector 30A works well with high BTU fuels such as natural gas, when gaseous fuels having a lower heating value is used with GTE 100, fuel injector 30A may have disadvantages. When a HBTU fuel is replaced with a MBTU fuel or a LBTU fuel, the mass flow rate of the lower BTU fuel delivered to combustor 50 must be increased (to account for the lower heating value of the fuel) to maintain the same level of power produced by GTE 100. Increasing the mass flow rate of fuel may require an increase in the pressure of the fuel (fuel pressure) delivered to fuel injectors 30A through fuel manifold 34 (see FIG. 1). As mentioned earlier, increasing fuel pressure may nessitate upgrading of fuel pumps and other ancilliary devices.

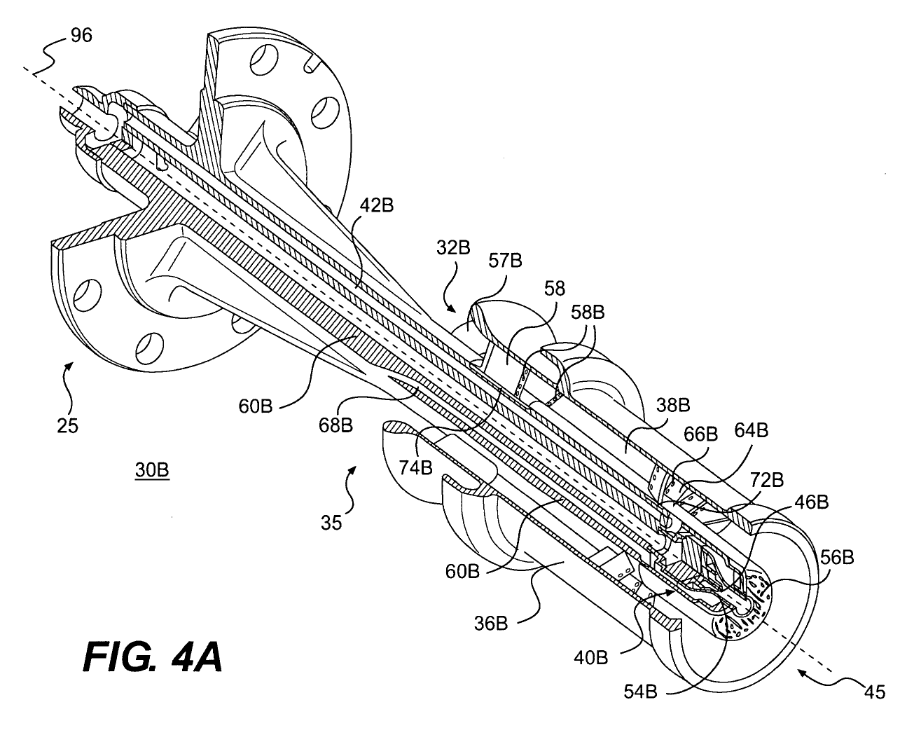

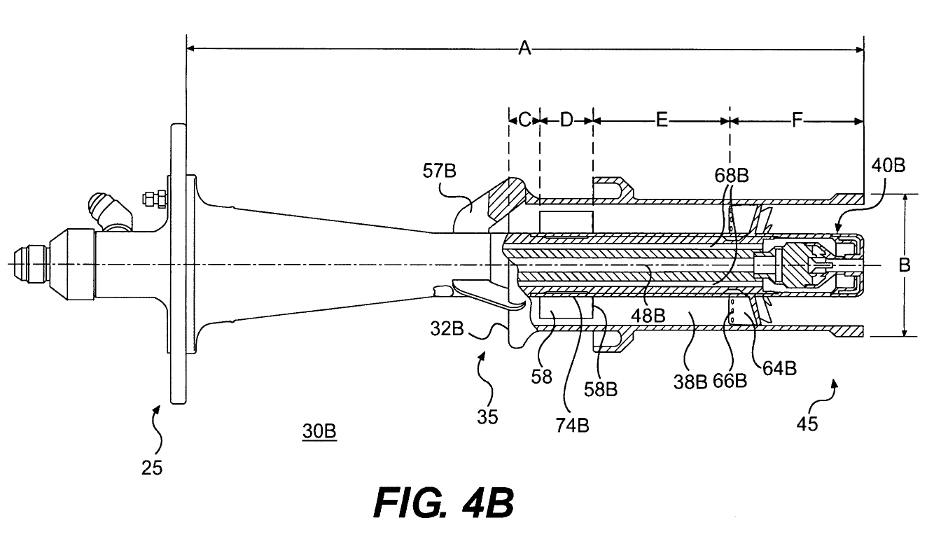

FIGS. 4A and 4B illustrate another embodiment of fuel injector 30 that may be used with GTE 100. In fuel injector 30B illustrated in FIGS. 4A and 4B, the mass flow rate of flow may be increased without a substantial increase in fuel pressure. FIG. 4A illustrates a cutaway view of fuel injector 30B and FIG. 4B illustrates a cross-sectional view. External dimensions of fuel injector 30B may substantially match fuel injector 30A so that fuel injector 30A may be replaced with fuel injector 30B when GTE 100 is modified to use a lower BTU fuel. For the sake of brevity, only those aspects of fuel injector 30B that are different from fuel injector 30A of FIG. 3 will be emphasized in the discussion that follows. Fuel injector 30B may have substantially the same total length (A) and diameter (B) as fuel injector 30A. Similar to fuel injector 30A of FIG. 3, fuel injector 30B may also include a tubular premix barrel 36B circumferentially disposed around a stem 60B, and a pilot assembly 40B coupled to stem 60B proximate first end 45. Support structures 57B may support premix barrel 36B around stem 60B. Main fuel duct 38B, formed between premix barrel 36B and stem 60B, may form the main fuel flow path that directs a premixed fuel-air mixture to combustor 50. Similar to pilot assembly 40A of fuel injector 30A, pilot assembly 40B may include the pilot fuel flow path that delivers a stream of pressurized fuel and air to combustor 50, through pilot fuel nozzle 46B and air nozzles 54B located at first end 45 of fuel injector 30B. As in fuel injector 30A, fuel from main fuel tube 42B may be injected into the compressed air in main fuel duct 38B to form the premixed fuel-air mixture. However, while the fuel is injected into main fuel duct 38A only through second orifices 66A in fuel injector 30A, fuel may injected into main fuel duct 38B of fuel injector 30B through additional locations.

Fuel in main fuel tube 42B may be injected into main fuel duct 38B through first orifices 58B on strut structure 58 located downstream of air inlet port 32B. Strut Structure 58 may include a plurality of structures (or struts) positioned in main fuel duct 38B, down stream of air inlet port 32B, and extending a small distance along the length of fuel injector 30B. Strut Structure 58 may project radially outwards of stem 60B. Although the number, size, and location of struts in strut structure 58 may depend on the application, in some embodiments, strut structure 58 may include 4 to 8 struts, each having a length (D) between about 19 mm and 50 mm, may be symmetrically located around longitudinal axis 96. In some embodiments, these struts may be positioned at a distance (C), between about 5 mm and 40 mm, downstream of air inlet port 32B. First orifices 58B may include a plurality of openings on the downstream end of strut structure 58, or in other locations around the struts. The number and size of first orifices 58B may depend upon the application. A first fuel gallery 74B may fluidly couple first orifices 58B to main fuel tube 42B. First fuel gallery 74B may include an annular cavity on stem 60B. Passages (not shown) may connect first fuel gallery 74B to main fuel tube 42B and first orifices 58B. Compressed air entering main fuel duct 38B through air inlet port 32B may travel to combustor 50 through spaces between the struts of strut structure 58. The fuel from first orifices 58B may mix with this compressed air to form a premixed fuel-air mixture. This premixed fuel-air mixture may flow past an air swirler 64B located on main fuel duct 38B.

Air swirler 64B may be similar to air swirler 64A of fuel injector 30A and may be attached to an external surface of stem 60B downstream of strut structure 58. While the location and number of blades of air swirler 64B may depend upon the application, in some embodiments, 10 to 14 blades may be symmetrically located around longitudinal axis 96 at a distance (E) between about 60 mm and 140 mm down stream of strut structure 58. Air swirler 64B may also include second orifices 66B that may inject fuel into the premixed fuel-air mixture flowing past air swirler 64B. Second orifices 66B may be similar to second orifices 66A of fuel injector 30A and may be fluidly coupled to main fuel tube 42B through a second fuel gallery 72B. While second orifices 66B may be located anywhere on air swirler 64B, in some embodiments, second orifices 66B may be located on the upstream side of air swirler 64B, at a distance (F) between about 50 mm and 150 mm from first end 45 of fuel injector 30B.

The fuel injected through second orifices 66B may mix with the premixed fuel-air mixture flowing past air swirler 64B. The swirl in the current, induced by air swirler 64B, may help the fuel mix thoroughly with the fuel-air mixture. Since fuel is injected into main fuel duct 38B through both first orifices 58B and second orifices 66B in fuel injector 30B, the mass flow rate of fuel delivered to combustor 50 may be increased without increasing the pressure of fuel supplied to fuel injector 30B. In some applications, dividing the total fuel delivered to the main fuel duct 38B into two parts and injecting these parts into the air stream separately may create a better mixed fuel-air mixture, than if the total fuel were injected into the main fuel duct 38B at one location. The proportion of the total fuel injected at the first orifices 58B and the second orifices 66B may depend upon the application. In some embodiments, about half the total fuel delivered through the main fuel flow path may be delivered through the first orifices 58B, while the other half of the total fuel may be delivered through second orifices 66B. However, in general, any portion of the total fuel may be delivered through the first and second orifices 58B and 66B.

### INDUSTRIAL APPLICABILITY

The disclosed gas turbine fuel injector for high flow rate may be applicable to any turbine engine where substitution of a higher BTU fuel with a lower BTU fuel is desired. The disclosed fuel injector may enable the higher BTU fuel to be switched with a lower BTU fuel without the need for redesigning the GTE to use the lower BTU fuel. An exemplary application will now be described to illustrate the operation of a fuel injector of the current disclosure.

GTE 100 may operate using a natural gas fuel to produce about 4.5 MW (megawatts) of power. To produce this amount of power, about 2000 lb/hr of natural gas (1200 Wobbe fuel) at a fuel pressure of about 180 psig may be delivered through eight fuel injectors 30A coupled to combustor 50 of GTE 100. A user of GTE 100 may decide to switch the fuel supplied to GTE 100 from natural gas to a MBTU fuel (such as, landfill gas) having Wobbe index of about 600 Wobbe. To continue producing the same amount of power (about 4.5 MW), about 4000 lb/hr of the 800 Wobbe fuel may need to be supplied to combustor 50. To deliver about 4000 lb/hr of fuel through fuel injector 30A, fuel pressure may have to be increased to about 250 psig. To increase the fuel pressure, fuel pumps and/or other components associated with the fuel supply system of GTE 100 may need to be replaced. Additionally, efficiency of GTE 100 may be decrease since more energy may be consumed to compress the fuel to the higher pressure. In order to minimize the decrease in efficiency, fuel injectors 30A may be replaced with fuel injectors 30B.

The MBTU fuel, at a pressure between about 160-200 psig, may be directed from fuel manifold 34 into each fuel injector 30B through main fuel tube 42B and pilot fuel tube 44B. Compressed air may also be directed into fuel injector 30B from first space 24A. This compressed air may be directed into main fuel duct 38B through air inlet port 32B and into pilot assembly 40B through air passage 68B. The fuel in pilot fuel tube 44B, along with compressed air, may be injected into combustor 50 through pilot assembly 40B. A portion of the fuel in main fuel tube 42B may be injected into the compressed air passing through main fuel duct 38B through first orifices 58B located on strut structure 58. This injected fuel may mix with compressed air flowing past strut structure 58 to create a premixed fuel-air mixture. The remaining portion of the fuel in main fuel tube 42B may be injected into the premixed fuel-air mixture through second orifices 66B located downstream of strut structure 58. The additional fuel injected through second orifices 66B may also mix with the premixed fuel-air mixture to create a fuel-air mixture having a higher fuel content. This premixed fuel-air mixture may be directed into combustor 50. Combustion of the premixed fuel-air mixture, delivered through main fuel duct 38B, and the fuel/air injection, delivered through the pilot assembly 40B, may produce high pressure exhaust gases that may be used in other systems of GTE to produce about 4.5 MW of power.

Injecting fuel into the compressed air stream in main fuel duct 38B at multiple locations, longitudinally displaced from each other, allows a higher mass flow rate of the lower BTU fuel to be delivered to combustor 50 without substantially increasing the gas pressure. A sufficient quantity of the lower BTU fuel may be delivered to combustor 50 in this manner to maintain about the same level of power production as the natural gas burning GTE. Dividing the total fuel injected into main fuel duct 38B into two parts and injecting these parts into the compressed air stream separately may create a well mixed fuel-air mixture than burns uniformly in combustor 50.

It will be apparent to those skilled in the art that various modifications and variations can be made to the disclosed fuel injector. Other embodiments will be apparent to those skilled in the art from consideration of the specification and practice of the disclosed fuel injector. It is intended that the specification and examples be considered as exemplary only, with a true scope being indicated by the following claims and their equivalents.

We claim:

1. A fuel injector for a gas turbine engine, comprising:
a stem extending along a longitudinal axis from a proximal end to a distal end, the stem including a fuel tube configured to deliver a fuel toward the distal end of the stem;
a pilot assembly coupled to the distal end of the stem, the pilot assembly including one or more components configured to inject fuel into a combustor of the engine;
a substantially tubular premix barrel extending along the longitudinal axis from a first end to a second end, the premix barrel being circumferentially disposed about the stem and configured to couple with the combustor at the second end; and
an annular premix duct formed between the premix barrel and the stem, the premix duct including;
an air inlet port at the first end,
a plurality of first orifices located downstream of the air inlet port, the first orifices configured to inject fuel from the fuel tube into the premix duct, and
a plurality of second orifices located downstream of the first orifices, the second orifices configured to inject fuel from the fuel tube into the premix duct.

2. The fuel injector of claim 1, wherein the plurality of first orifices are located on a strut structure positioned in the premix duct.

3. The fuel injector of claim 2, wherein the strut structure includes a plurality of struts projecting radially outwards from the stem, the plurality of struts being symmetrically positioned about the longitudinal axis.

4. The fuel injector of claim 2, wherein the strut structure includes between 4 to 8 struts symmetrically disposed about the longitudinal axis, each strut extending a length between about 19 mm and 50 mm along the longitudinal axis.

5. The fuel injector of claim 2, wherein the strut structure is located at a distance between about 5 mm and 40 mm downstream of the air inlet port.

6. The fuel injector of claim 1, further including a first fuel gallery that fluidly couples the first orifices to the fuel tube, the first fuel gallery being an annular cavity on the stem.

7. The fuel injector of claim 1, further including an air swirler located in the premix duct downstream of the first orifices, the air swirler including a plurality of blades annularly positioned about the longitudinal axis.

8. The fuel injector of claim 7, wherein the second orifices are located on the air swirler.

9. The fuel injector of claim 1, further including a second fuel gallery that fluidly couples the second orifices to the fuel tube, the second fuel gallery being an annular cavity on the stem.

10. The fuel injector of claim 1, wherein the second orifices are located at a first distance downstream of the first orifices, the first distance being a distance between about 60 mm and 140 mm.

11. The fuel injector of claim 1, wherein the second orifices are located at a distance upstream of the second end, the distance being between about 50 mm and 150 mm.

12. The fuel injector of claim 1, wherein the fuel is one of a MBTU and a LBTU fuel.

13. A method of delivering a fuel to a gas turbine engine using a fuel injector, comprising:
directing a first part of the fuel into a combustor of the engine as a fuel-air stream through a pilot assembly;
injecting a second part of the fuel into a stream of compressed air at a first location to form a fuel-air mixture;
moving the fuel-air mixture to a second location downstream of the first location;
injecting a third part of the fuel into the fuel-air mixture at the second location; and
directing the fuel-air mixture into the combustor after the injection of the third part.

14. The method of claim 13, further including mixing the third part of fuel in the fuel-air mixture by inducing a swirl in the fuel-air mixture.

15. The method of claim 13, further including directing compressed air into the fuel injector through an air inlet port, wherein the air inlet port is located upstream of the first location.

16. The method of claim 15, wherein the first location is between about 24 mm and 90 mm downstream of the air inlet port.

17. The method of claim 13, wherein moving the fuel-air mixture to the second location includes moving the fuel-air mixture to the second location which is at a distance between about 60 mm and 140 mm from the first location.

18. A gas turbine engine, comprising:
a compressor;
a combustor fluidly coupled to the compressor and annularly disposed about a first longitudinal axis, the combustor configured to produce combustion gases by burning a fuel;
a plurality of fuel injectors configured to deliver the fuel to the combustor, each fuel injector including;
one or more fuel tubes extending along a second longitudinal axis,
a pilot assembly disposed along the second longitudinal axis and configured to inject the fuel into the combustor;
a substantially cylindrical premix barrel disposed radially outwards of the pilot assembly and extending from an air inlet port at a first end to the combustor at a second end opposite the first end, the premix barrel forming an annular premix duct in a space between the premix barrel and the pilot assembly;
a plurality of first orifices located downstream of the air inlet port, the first orifices configured to inject fuel from the fuel tube into the premix duct, and
a plurality of second orifices located downstream of the first orifices, the second orifices configured to inject fuel from the fuel tube into the premix duct; and
a turbine configured to extract power from the combustion gases.

19. The gas turbine of claim 18, further including a strut structure disposed at a distance between about 5 mm and 40 mm downstream of the air inlet port, the strut structure including a plurality of struts symmetrically positioned about the second longitudinal axis and extending a distance between about 19 mm and 50 mm along the second longitudinal axis, the first orifices being located on the strut structure.

20. The gas turbine of claim 18, wherein the second orifices are located on an air swirler such that a distance of the second orifices and the first orifices is between about 60 mm and 140 mm.
